(19) United States
(12) Patent Application Publication
(10) Pub. No.: US 2007/0208893 A1
(43) Pub. Date: Sep. 6, 2007

(54) File-based compression on a fat volume

(75) Inventors: Patrick B. Azzarello, Issaquah, WA (US); Anil A. Ingle, Woodinville, WA (US); Oren Winter, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/360,909

(22) Filed: Feb. 23, 2006

(51) Int. Cl. G06F 13/12

(52) U.S. Cl. 710/68

(57) ABSTRACT

Individual files within a FAT volume may be compressed while other files remain uncompressed. A FAT Compression Filter (FCF) intercepts calls to the file system, performs the compression and decompression tasks relating to the files on the FAT volume. The use of individual file compression with the FAT file system helps to ensure that the flash memory has a long life and does not quickly fail while still providing the benefits of individual file compression. The FAT Compression Filter allows individual files within a volume to be excluded from being compressed.

### BACKGROUND

Memory is a precious resource on embedded systems. For many embedded devices, flash memory is the storage medium of choice. Flash memory, however, is an expensive non-volatile memory that may be only written to a limited number of times before it fails. The failure of the flash memory occurs since each flash sector only has a limited number of write events that it may execute before it fails and burns out. In order to save cost, many systems attempt to minimize the amount of flash memory required. While the NTFS (New Technology File System) provides compression support that would save memory space, it is not typically used with flash memory. Using NTFS with flash memory may cause the memory to quickly fail since NTFS writes a log file to a specific sector on the media on a regular basis thereby exceeding its allowed write events. Additionally, NTFS requires a larger amount of space overhead as compared to other file systems. The use of the File Allocation Table (FAT) file system is commonly used with flash memory. Sector or volume based compression that is used in conjunction with FAT compresses the entire volume which may cause some applications and operating system components to perform slowly or improperly.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Individual files within a FAT volume may be compressed while other files remain uncompressed. A FAT Compression Filter (FCF) program intercepts file requests to the file system and performs compression and decompression tasks relating to the files on the FAT volume. An API may be used to configure and perform actions relating to the compression and decompression of the files stored on a FAT volume. The use of individual file compression with the FAT file system helps to ensure that the flash memory has a long life and does not quickly fail while still providing the benefits of individual file compression. The FAT Compression Filter allows individual files within a volume to be excluded from being compressed. Generally, files that are excluded from being compressed are files that when compressed would adversely affect an application's performance.

### BRIEF DESCRIPTION OF THE DRAWINGS

FIG. 1 illustrates an exemplary computing architecture;

FIG. 2 shows a FAT compression system with individual file compression;

FIG. 3 shows the mapping between an uncompressed file and a compressed file on a FAT volume;

FIG. 4 shows a process for receiving a read request;

FIG. 5 illustrates a process for receiving a write request; and

FIG. 6 shows a process for creating a file on a FAT volume.

### DETAILED DESCRIPTION

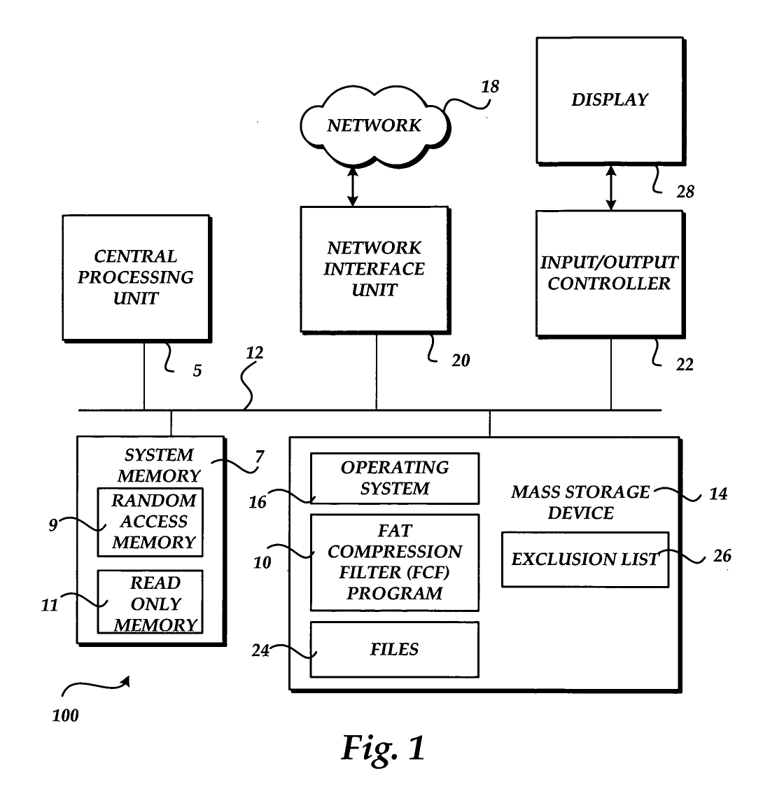

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a mobile computing device and/or a conventional computing device. For example, computing device 100 may be configured as a smart phone, a PDA, a desktop computer, a server, a tablet, a laptop computer, and the like.

As illustrated, computer 100 includes a central processing unit 5 (“CPU”), a system memory 7, including a random access memory 9 (“RAM”) and a read-only memory (“ROM”) 11, and a system bus 12 that couples the memory to the CPU 5. System memory 7 may be any combination of non-volatile memory and volatile memory. A basic input/output system containing the basic routines that help to transfer information between elements within the computer, such as during startup, is stored in the ROM 11. The computer 100 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk, DVD drive or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, the computer 100 may operate in a networked environment using logical connections to remote computers through a network 18, such as the Internet. The computer 100 may connect to the network 18 through a network interface unit 20 connected to the bus 12. The network interface unit 20 may also be utilized to connect to other types of networks and remote computer systems. The connection may be a wired and/or wireless connection. The computer 100 also includes an input/output controller 22 for receiving and processing input from a number of devices, such as: a keyboard, mouse, electronic stylus and the like. Similarly, the input/output controller 22 may provide output to a display 28, speakers, or some other type of device.

As mentioned briefly above, a number of program modules and data files may be stored in the memory of the computer 100, including an operating system 16 suitable for controlling the operation of a computing device, such as the WINDOWS MOBILE or WINDOWS XP operating systems from MICROSOFT CORPORATION of Redmond, Wash. The computing device 100 may be an embedded system that includes an embedded operating system as well as other embedded data, files and applications.

The operating system 16 may utilize the FAT file system. Generally, the FAT file system allows an operating system to keep track of the location and sequence of each piece of a file. Additionally, the FAT file system allows the operating system 16 to identify the clusters that are unassigned and available for new files. When a request is received to read a file, the FAT file system reassembles each piece of the file into one unit for viewing.

According to one embodiment, all or some of the memory the may be FLASH memory, or some other suitable memory for embedded systems. The mass storage device 14 and RAM 9 may also store one or more program modules. In particular, the mass storage device 14 and the RAM 9 may store a FAT compression filter (FCF) program 10. The FCF program 10 is operative to provide functionality for interacting with and compressing/decompressing files 24 and interacting with operating system 16. For example, FCF program 10 is configured to individually intercept calls to the FAT file system, perform the compression and decompression tasks, and return the data to/from the volume on the mass storage device or to/from the requesting application. The use of individual file compression with the FAT file system helps to ensure that the flash memory has a long life and does not quickly fail while providing individual file compression. Individual files within a FAT volume may be excluded from being compressed. As such, an exclusion list 26 may be utilized to facilitate excluding specific files from being compressed. Other types of indicators may be used to indicate whether or not a file should be compressed. For example, each file may have an indicator within a header; the filename may indicate whether it should be compressed, and the like. Generally, the files that are excluded from compression are files that are required early in the boot process of a computing device or those files that adversely affect an application's performance when compressed. The determination of the files to be excluded from compression may be configured by an authorized user. For example, in one application, an authorized user may be a system administrator whereas in another application an authorized user may be the user of computing device 100. Additional details regarding the operation of the FCF program 10 will be provided below.

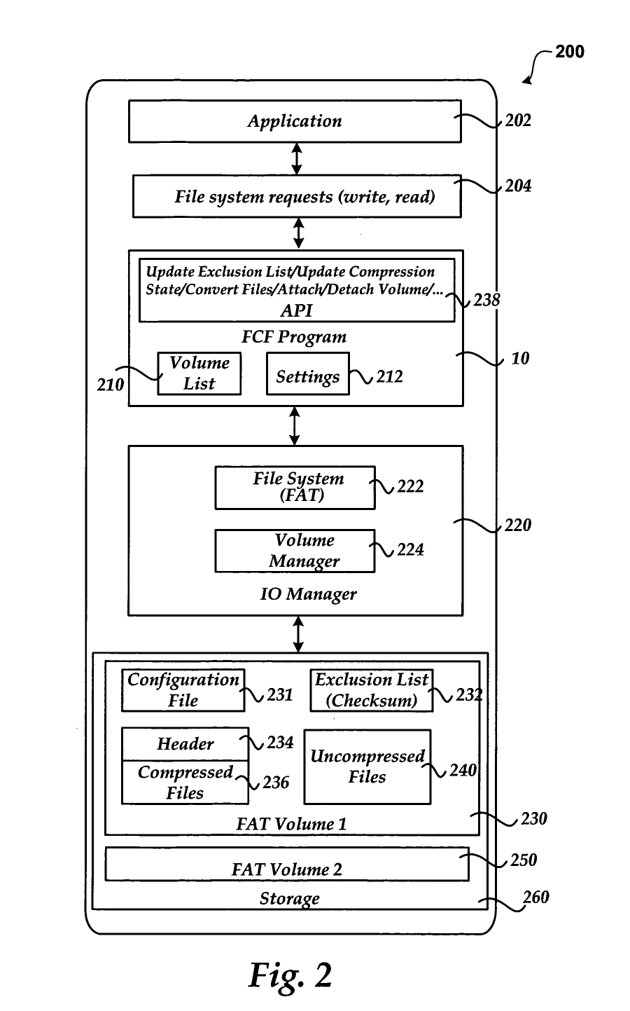

FIG. 2 shows a FAT compression system with individual file compression. As illustrated, FAT compression system 200 includes application 202, file system requests 204, FCF program 10, volume list 210, settings 212, IO Manager 220, file system 222, volume manager 224, FAT Volumes 230 and 250, exclusion list 232, compressed files 236 that includes header 234, uncompressed files 240, application programming interface (API) 238 and storage 260.

Generally, FAT compression system 200 allows individual files within a FAT volume to be compressed while other files remain uncompressed. The FAT Compression Filter (FCF) program 10 intercepts file system requests 204 made by an application (e.g. application 202) to the file system 222 and performs the compression and decompression tasks relating to the files. Files that are typically excluded from being compressed are boot files and files that when compressed adversely affect an application's performance. The files stored on the FAT volume may be a mixture of compressed files 236 and uncompressed files 240. The files may also reside on one or more FAT volumes (e.g. FAT volume 1 230 and FAT volume 2 250). The FCF program 10 allows individual files within a volume to be excluded from being compressed.

Exclusion list 232 is used to identify the files that should not be compressed. Exclusion list 232 may also include folders or paths that are not to be compressed. The exclusion list 232 may be configured to compress all/or part of the files and/or subdirectories that are contained within a folder or below a specified path. The exclusion list 232 may also include a checksum to allow the FCF program 10 to determine whether the exclusion list file has been tampered with or has been corrupted. Other methods may also be used to determine if the exclusion list has been tampered with and/or corrupted.

FCF program 10 includes settings 212. The settings 212 may include many different types of settings relating to the operation of FCF program 10. For example, settings 212 may include a list of files to always exclude from being compressed, a default compression algorithm, a minimum compression threshold, and the like. Settings 212 may be configured globally, by volume, by folder, or by file.

The FCF program 10 also includes a volume list 210 that defines which FAT volumes are attached and that include files that should be compressed by FCF program 10. When a new FAT volume is accessed, the FCF program 10 checks the root of the FAT volume for a configuration file 231. If the configuration file 231 exists and specifies that it is to be attached to the FCF program 10 then the volume is attached to the FCF program 10 and the volume list 210 is updated. Similarly, when a volume is unattached the volume is removed from volume list 210. Many other ways may be used to determine whether a FAT volume is attached to FCF program 10. For example, any FAT volume that resides on a computing device may be automatically attached, only specified FAT volume(s) are attached, and the like.

Both compressed files 236 and uncompressed files 240 reside on a FAT volume. According to one embodiment, each compressed file 236 includes a header 234 that is utilized by the FCF program 10. According to one embodiment, the header 234 includes a signature; a compression type; a checksum; and compression mapping information. Among other uses, the FCF program 10 uses header 234 to identify whether a file is compressed. When a file includes header 234 then the file is compressed. When a file does not include header 234 then the file is not compressed. This allows system 200 to read files without a separate mapping file, as well as making the files portable and allowing for different compression algorithms to be used on the same file system. The unique signature within the header 234 may also be used to identify the file as a compressed file.

The compression type within header 234 may be used to specify a compression algorithm to be used in performing the compression on the file. According to one embodiment, files are compressed by default using a ZIP compression algorithm, such as the MSZip compression algorithm. Other compression algorithms may be specified. For example, an LZNT compression algorithm may be used. Compression algorithms offer different advantages. Generally, the tradeoff is between space and performance. The ability to select a compression algorithm allows applications and devices to be optimized for their particular use.

Other methods may be used to identify the compression algorithm. For example, all files may be compressed using a default compression algorithm, a list may be included that identifies each file and its compression algorithm, and the like. Including the type of compression algorithm within the header 234 of each of the compressed files 236 helps to ensure that the compressed file 236 will be accessible even if the file system supports a different default compression algorithm. According to one embodiment, once a file has been compressed using one compression algorithm, any updates to the file continue to use the same compression algorithm. To change the compression algorithm, the file is uncompressed by FCF program 10 and then recompressed by FCF program 10 using the selected compression algorithm.

When application 202 requests data to be read from an attached FAT volume (e.g. FAT volume 230), the FCF program 10 identifies whether or not the file is compressed. According to one embodiment, the FCF program 10 determines whether the file includes header 234. If the file does include the header, the FCF program 10 reads the data from the file, decompresses the requested portion of the file, and passes the requested data back to the requesting application 202 through file system requests 204. When the file does not include the header, the FCF program 10 passes back the requested data without performing any decompression on the data.

When a write is requested by application 202, the FCF program 10 receives the request through file system requests 204 and determines whether the file is compressed or should be compressed (e.g. a copy to a different volume, the file does not currently exist, etc.). When the file does not already exist in the FAT volume, then the exclusion list 232 is accessed to determine whether to compress the file before it written to the FAT volume. As with the read request, a determination is made as to whether the file includes header 234. When the file includes header 234, the FCF program 10 determines the compression algorithm specified in header 234 and uses the specified compression algorithm to compress the data before writing the data to the file on the FAT volume. When the file does not include the header, the data is written to the file on the FAT volume without being compressed.

When copying a file on a FAT volume, the compression system 200 writes a new file to the specified location. If the file is copied to a location that specifies the file to be compressed then the file is compressed before being stored on the FAT volume. Moving a file within the same FAT volume changes the file location in the file allocation table and does not change the compression of the file. Alternatively, a move may involve determining whether the file should be compressed or uncompressed in the new location. In this example, the move would be treated as a copy with the original file being removed from the FAT volume after being moved. Similarly, moving a file across volumes involves copying the file to the new volume and then deleting the file on the original volume.

According to one embodiment, if the file that is being copied to a volume on another device where it will be stored in a compressed format then the file is recompressed on the destination device by the FCF program. This helps to ensure that each device may interact with the compressed files. According to another embodiment, the file may be copied to the new location in the compressed format. In this situation it should be ensured that the device includes support for the specified compression algorithm.

According to one embodiment, if the file is to be compressed, the FCF program 10 determines if the file in a compressed state meets a minimum compression threshold (e.g. a savings of <5% by default). Other thresholds may be utilized. If the file does not meet the minimum compression threshold then the file is stored as an uncompressed file to help ensure that there is no degradation in performance. Files excluded from compression for not meeting the minimum compression threshold are added to the exclusion list 232 and are marked as not meeting the minimum compression threshold. Any file that is marked as not meeting the minimum compression threshold may be periodically retested according to the specified settings. The value for the minimum compression threshold may be stored within settings 212 and may be configured many different ways. For example, the minimum compression threshold may be configured using API 238.

According to one embodiment, known boot files to the FCF program 10 remain uncompressed and may not be compressed. The boot files may be dynamically identified by FCF program 10 by searching the run-times registry for boot drivers. These boot drivers may be added to the exclusion list 232 and/or settings 212 and marked as mandatory. When marked as mandatory, the file is never compressed.

API 238 provides an interface to interact with and adjust settings relating to compressing individual files on a FAT volume. API 238 may be utilized to remove a file or path from the exclusion list 232; commit exclusion list changes now; set whether a specific file (or files within a folder or files below a path) are to be either compressed or uncompressed; update the compressed state of files; apply changes to only new files; attach/detach a volume; and change the default compression type. A command line tool may also be used to configure the settings relating to compressing the files on a FAT volume. For example, the command line tool may be used attach or detach a volume to the FCF program, display the exclusion list, and the like. The following is a list of exemplary functions that may be utilized within API 238. Other combination of functions may also be utilized.

An Update Exclusion List is used to add, remove, display, and change information in the exclusion list 232.

A Convert Files function is used to make changes to the compressed state of a file, or files within a directory structure. According to one embodiment, the convert files function includes may utilize the following arguments. The “Subdirs” argument forces the changing of all files within the directory and its subdirectories to the specified compression state. The “C” or compress argument compresses the file. The “U” or uncompress argument decompresses the file. The FORCE argument in combination with any of the other arguments forces the change to the file regardless of the files inclusion within the exclusion list 232. An argument may also be supplied that specifies the compression algorithm to use (e.g. -LZNT, -MSZip, and the like).

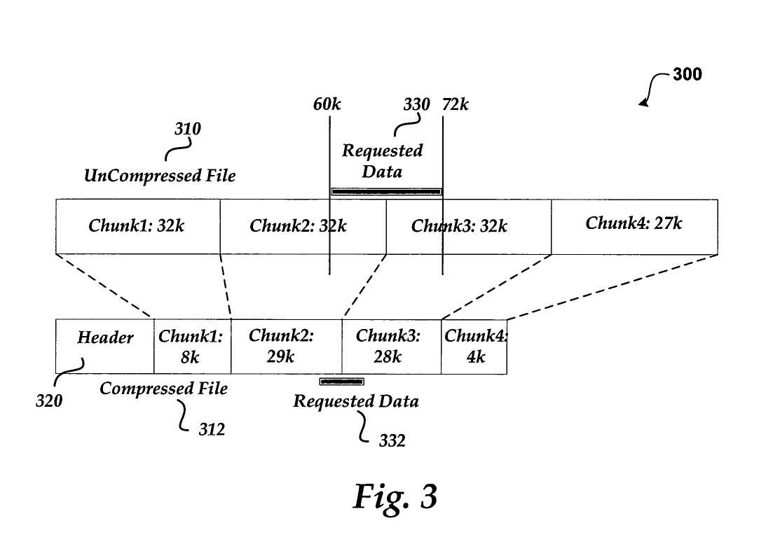

FIG. 3 shows the mapping between an uncompressed file and a compressed file on a FAT volume. Uncompressed file 310 represents a file that is stored in 32 k “chunks.” Other chunk sizes may be used. When uncompressed file 310 is compressed to become compressed file 312 a header 320 is added to the file and each chunk (1-4) within uncompressed file 310 is compressed and stored after header 320. As can be seen chunk 1 in the original uncompressed file 310 was reduced in size by 24 k; chunk 2 was reduced in size by 3 k; chunk 3 was reduced in size by 4 k; and chunk 4 was reduced in size by 23 k. As mentioned briefly above, the header includes a mapping of the compressed chunks (to allow for fragmentation). In the following example, a request was made for 12 k of data in uncompressed file 310 that starts 60 k into the uncompressed file 310. The mapping information that is included in header 320 is used to determine where to access the requested data in compressed file 312.

The FCF program intercepts file requests before they are sent to the file system. To account for the change in file structure due to compression, the file request is modified by mapping the offset from the uncompressed file to the compressed file. In this example, a request for Chunks 2 and 3 is sent to the stack of the file system, which handles the disk IO. The file system then returns the compressed data (chunks 2 and 3) of compressed file 312. The FCF program intercepts the returned data, decompresses the data, truncates any extra data that was not requested and then returns the data as requested.

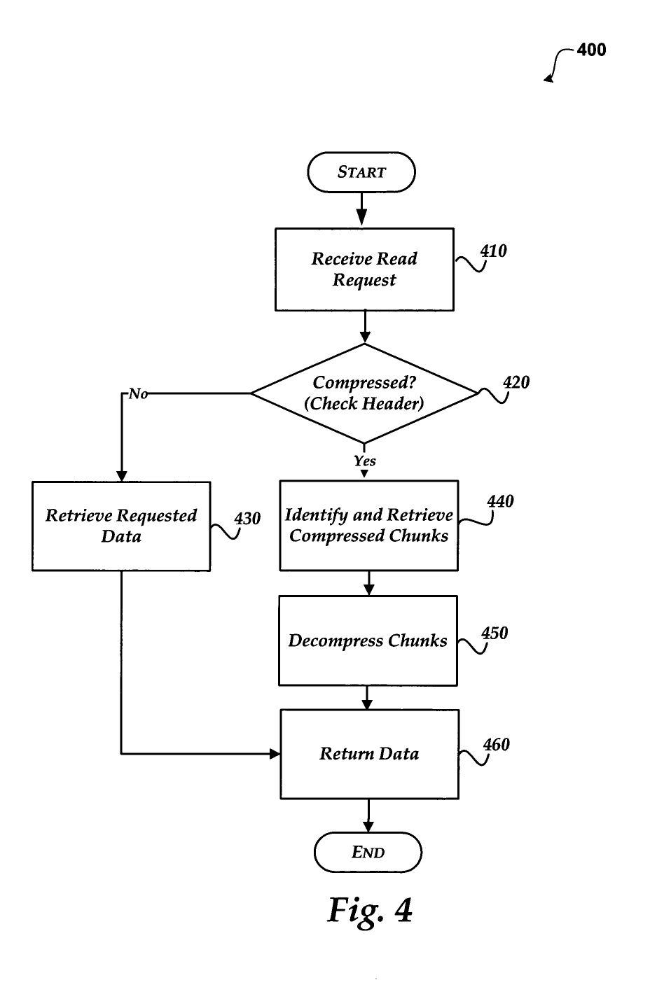

Referring now to FIGS. 4-6, an illustrative process for compressing individual files on a FAT volume will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations illustrated and making up the embodiments of the described herein are referred to variously as operations, structural devices, acts or modules. These operations, structural devices, acts and modules may be implemented in software, in firmware, in special purpose digital logic, and any combination thereof.

FIG. 4 shows a process 400 for receiving a read request. After a start operation, the process moves to operation 410 where a read request is received. The read request may be for data within a compressed file or for data within an uncompressed file. According to one embodiment, the read request is intercepted by the FCF program before it reaches the file system.

Moving to decision operation 420, a determination is made as to whether the file from which data has been requested is compressed. According to one embodiment, the file is compressed when it includes a header.

When the file is not compressed, the process flows to operation 430 where the requested data is retrieved from the uncompressed file. The process then moves to operation 460 where the data is returned.

When the file is compressed, the process flows to operation 440 where the requested data is located and retrieved from the compressed file. According to one embodiment, the header within the compressed file includes mapping information that indicates where to access the requested data within the compressed file.

Moving to operation 450, the retrieved data is decompressed using the specified compression algorithm. The operation then moves to operation 460 where the data is returned to the requesting application. The process then moves to an end operation and returns to processing other actions.

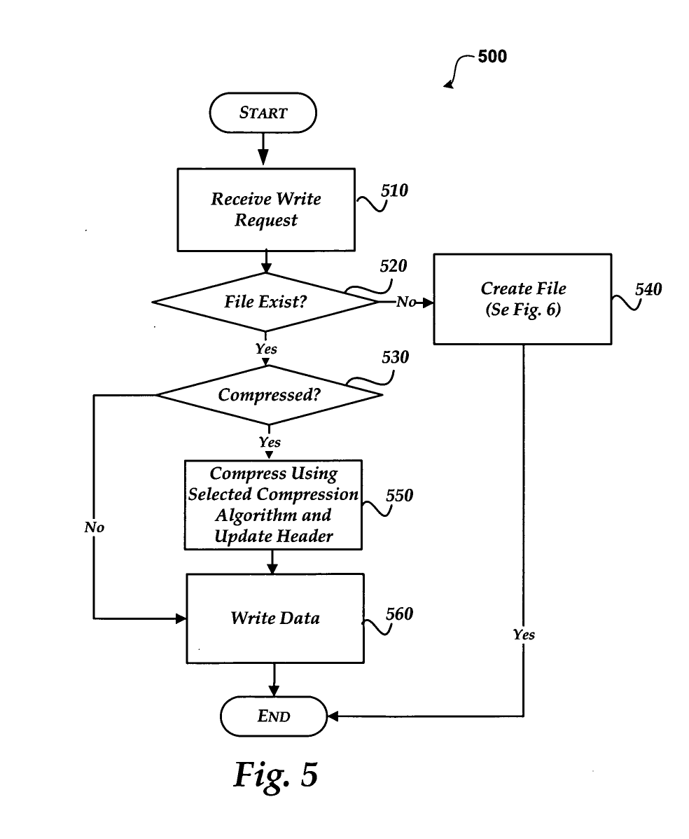

FIG. 5 illustrates a process 500 for receiving a write request. After a start operation, the process flows to operation 510 where a write request is received. The write request may request data to be written to a compressed file, an uncompressed file or to a file that does not currently exist on the FAT volume.

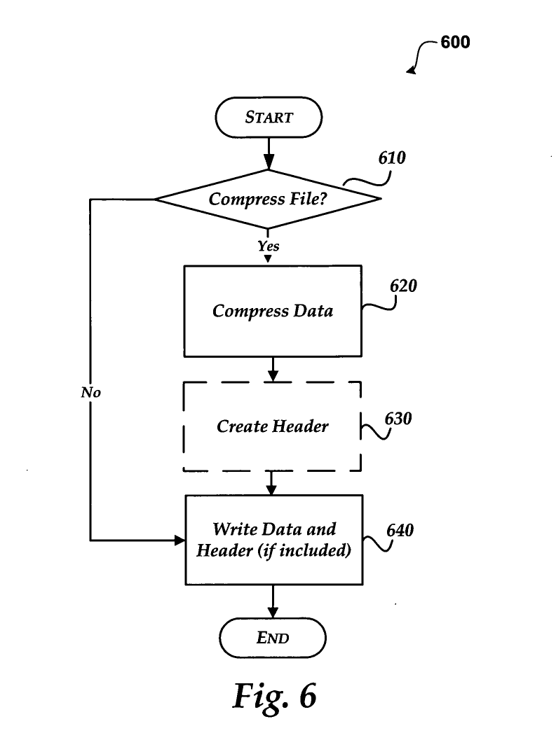

Moving to decision operation 520, a determination is made as to whether the write request is for a file that already exists on the FAT volume. When the file does not already exist, the process flows to operation 540 where the file is created (See FIG. 6 and related discussion.) Generally, the file is created as a compressed file or as an uncompressed file.

When the file already exists, the process flows to decision operation 530 where a determination is made as to whether the file is compressed. When the file is not compressed, the process flows to operation 560 where the uncompressed data is written to the file.

When the file is compressed, the process flows to operation 550 where the data that is associated with the write request is compressed using the selected compression algorithm. The header is also updated to include any changes to the mapping information. The process then moves to operation 560 where the compressed data is written to the file.

The process then moves to an end block and returns to processing other actions.

FIG. 6 shows a process for creating a file. After a start operation, process 600 flows to decision operation 610 where a determination is made as to whether the file should be compressed. According to one embodiment, an exclusion list is checked to determine whether the file should be compressed. When the file is not to be compressed, the process moves to operation 640 where the uncompressed data is written to the new file.

When the file is to be compressed, the process moves to operation 620 where the data is compressed using the selected compression algorithm. The process then flows to optional operation 630 where a header is created. As discussed above, the header includes information relating to the compression of the file as well as mapping information.

Moving to operation 640, the compressed data and header (if included) is written to the new file. The process then moves to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for compressing individual files on a FAT volume while other files remain uncompressed, comprising:
receiving a file system request to read or write data to a file on the FAT volume;
determining whether the file is compressed, and when the file is compressed:
compressing the data and writing the data to the file on the FAT volume when the file system request is to write the data; wherein the FAT volume includes files that are uncompressed and files that are compressed; and
accessing the file on the FAT volume; decompressing the data; and returning the decompressed data when the file system request is to read the data.

2. The method of claim 1, wherein receiving the file system request, comprises intercepting the file system request before it reaches the file system.

3. The method of claim 2, wherein determining whether the file is compressed comprises checking an exclusion list.

4. The method of claim 3, wherein the exclusion list includes files and folders that are to remain uncompressed.

5. The method of claim 3, further comprising storing boot files in the exclusion list.

6. The method of claim 1, wherein determining whether the file is compressed comprises determining whether the file includes an identifier indicating that the file is compressed.

7. The method of claim 6, wherein the identifier is a header that comprises a compression type portion and a mapping portion.

8. The method of claim 7, wherein compressing the data and decompressing the data is performed using a compression algorithm that is specified within the compression type portion of the header.

9. The method of claim 7, wherein accessing the file comprises accessing the mapping portion of the header and determining a mapping to the data within the file.

10. A system for compressing individual files on a FAT volume while other files remain uncompressed, comprising:
a FAT volume that includes both compressed files and uncompressed files; and
a File Compression Filter (FCF) program that is configured to perform actions, including to:
receive a file system write request to write data to one of the compressed files on the FAT volume;
receive a file system read request to read data from one of the compressed files on the FAT volume;
decompress the data from the one of the compressed files and return the decompressed data in response to the read request; and
compress the data and store the compressed data within the one of the compressed files in response to the write request.

11. The system of claim 10, further comprising an exclusion list that identifies files within the FAT volume that are to be compressed.

12. The system of claim 11, wherein the exclusion list includes a checksum that is used to indicate when the exclusion list has been changed.

13. The system of claim 11, wherein each of the compressed files on the FAT volume include a header that comprises a compression type that specifies a compression algorithm.

14. The system of claim 13, wherein the FCF program further comprises a volume list that indicates at least one attached FAT volume.

15. The system of claim 13, wherein the FCF program is further configured to determine whether a minimum compression threshold is met.

16. The system of claim 13, further comprising a second FAT volume that includes compressed files and uncompressed files and wherein the FCF program is further configured to copy and move the compressed files and the uncompressed files between the FAT volume and the second FAT volume.

17. A computer-readable medium having computer executable instructions for adjusting settings relating to individual compressed files on a FAT volume while other files remain uncompressed, the instructions comprising:
receiving a request to update one of: an exclusion list that lists files that are to remain uncompressed on the FAT volume; a compression state of a file on the FAT volume; and a compression algorithm; and
updating the one of the exclusion list; the compression state and the compression algorithm in response to the request.

18. The computer-readable medium of claim 17, wherein the request to update the exclusion list indicates to either: add to the exclusion list; remove from the exclusion list; display the exclusion list; and change an element within the exclusion list.

19. The computer-readable medium of claim 17, wherein the request to update the compression state of the file on the FAT volume includes an indication of whether to compress the file or whether to decompress the file.

20. The computer-readable medium of claim 17, wherein the request to update the compression algorithm comprises indicating a type of compression algorithm.
